(19) United States
(12) Patent Application Publication
(10) Pub. No.: US 2016/0187158 A1
(43) Pub. Date: Jun. 30, 2016

(54) DETECTION DEVICE

(71) Applicant: KABUSHIKI KAISHA TOKAI RIKA DENKI SEISAKUSHO, Aichi (JP)

(72) Inventor: Yoshihiro KIMURA, Aichi (JP)

(21) Appl. No.: 14/978,163

(22) Filed: Dec. 22, 2015

(30) Foreign Application Priority Data
Dec. 24, 2014 (JP) 2014-260886

(51) Int. Cl. G01D 5/14

(52) U.S. Cl. CPC G01D 5/14

(57) ABSTRACT

A detection device includes a constant-voltage source, a signal generating unit that generates a predetermined control signal, a sensor portion that receives power from the constant-voltage source via a switch portion and detects a state of a measuring object, the switch portion being on-off controlled by the control signal, and a hold circuit portion configured such that an output of the sensor portion is held and is then output under a predetermined condition based on the control signal.

The present application is based on Japanese patent application No. 2014-260886 filed on Dec. 24, 2014, the entire contents of which are incorporated herein by reference.

### BACKGROUND OF THE INVENTION

1. Field of the Invention

The invention relates to a detection device.

2. Related Art

A known example of a detection device is a magnetic sensor provided with a magnetoresistive element (e.g., JP-A-2014-95656). The magnetic sensor can correct a decrease in the output level of voltage signal from a bridge circuit having magnetoresistive elements due to temperature variation by a simple circuit configuration.

In detail, the magnetic sensor has a bridge circuit having a magnetoresistive pattern, a constant-voltage circuit outputting constant voltage, and an amplifier circuit changing an amplification factor based on variation in environmental temperature. The amplifier circuit amplifies the constant voltage and applies the amplified voltage to the bridge circuit. A change in a magnetic field, which is an object to be detected, is detected by the bridge circuit and the output from the bridge circuit is then amplified by the amplifier circuit and is output as a detection result.

### SUMMARY OF THE INVENTION

The magnetic sensor disclosed in JP-A-2014-95656 operates such that a constant voltage is supplied from the constant-voltage circuit to the bridge circuit having a magnetoresistive pattern. In forming the magnetic sensor into a sensor IC, the sensor IC is difficult to downsize since it is necessary to reduce the size of the magnetoresistive pattern and this causes a decrease in bridge resistance of the magnetoresistive pattern whereby the current consumption increases.

It is an object of the invention to provide a detection device that can be downsized in being formed into the sensor IC without increasing the current consumption.

(1) According to an embodiment of the invention, a detection device comprises:

a constant-voltage source;

a signal generating unit that generates a predetermined control signal;

a sensor portion that receives power from the constant-voltage source via a switch portion and detects a state of a measuring object, the switch portion being on-off controlled by the control signal; and

a hold circuit portion configured such that an output of the sensor portion is held and is then output under a predetermined condition based on the control signal.

In the above embodiment (1) of the invention, the following modifications and changes can be made.

(i) The signal generating unit and the hold circuit portion receive power at a constant voltage from the constant-voltage source.

(ii) The hold circuit portion comprises a latch circuit.

(iii) The hold circuit portion comprises a hold circuit.

(iv) The hold circuit comprises an analogue switch and a hold capacitor.

(v) The predetermined control signal comprises a time division signal.

(vi) The sensor portion comprises a sensor bridge

(vii) The sensor bridge comprises a plurality of magnetoresistive elements.

### Effects of the Invention

According to an embodiment of the invention, a detection device can be provided that can be downsized in being formed into the sensor IC without increasing the current consumption.

### BRIEF DESCRIPTION OF THE DRAWINGS

Next, the present invention will be explained in more detail in conjunction with appended drawings, wherein:

FIG. 1 is a circuit diagram showing a detection device in a first embodiment of the invention;

FIG. 2 is a circuit diagram showing the detection device in the first embodiment of the invention;

FIG. 3A is a circuit diagram showing a latch circuit as a hold circuit portion of the detection device in the first embodiment of the invention;

FIG. 3B is an illustration diagram showing a signal path when a latch signal is at Hi level;

FIG. 3C is an illustration diagram showing a signal path when the latch signal is at Lo level;

FIGS. 4A to 4F are signal waveform diagrams at various portions of the detection device in the first embodiment of the invention;

FIG. 5A is a circuit diagram showing a detection device in a second embodiment of the invention;

FIG. 5B is a circuit diagram showing a hold circuit as a hold circuit portion of the detection device;

FIGS. 6A to 6E are signal waveform diagrams at various portions of the detection device in the second embodiment of the invention;

FIG. 7A is a front view showing a movement detector when the detection device in the first embodiment of the invention is used in the movement detector;

FIG. 7B is a top plan view when viewed in an A-direction of FIG. 7A;

FIG. 7C is a waveform diagram showing a relation between a magnet position X and midpoint voltages Vm1 and Vm2 of a sensor bridge;

FIG. 7D is a signal waveform diagram showing the magnet position X and output V_{OUT};

FIG. 8 is an illustration diagram showing a rotation detector when the detection device in the second embodiment of the invention is used in the rotation detector; and

FIG. 9 is a waveform diagram showing an example of output waveform of the rotation detector.

### DETAILED DESCRIPTION OF THE PREFERRED EMBODIMENTS

### First Embodiment of the Invention

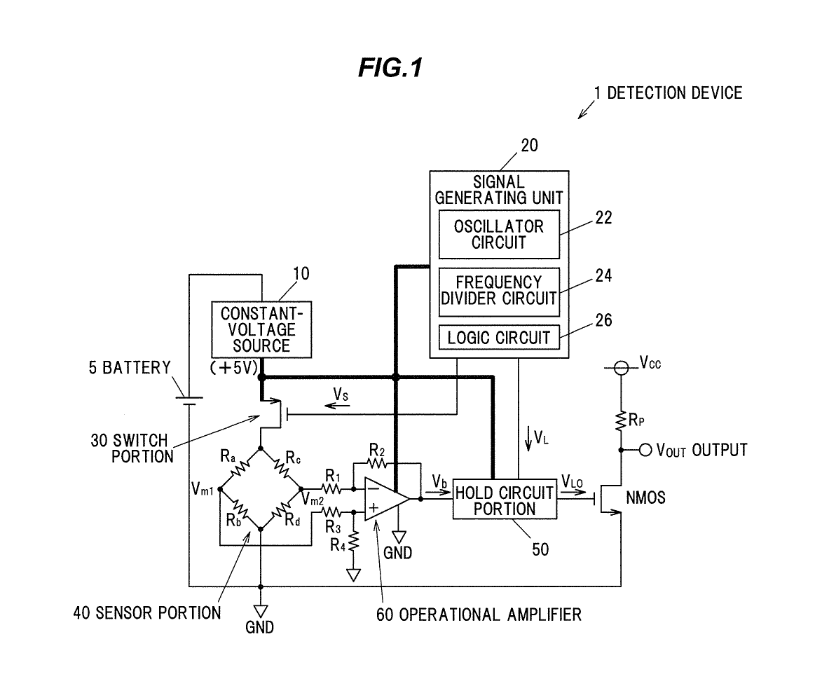

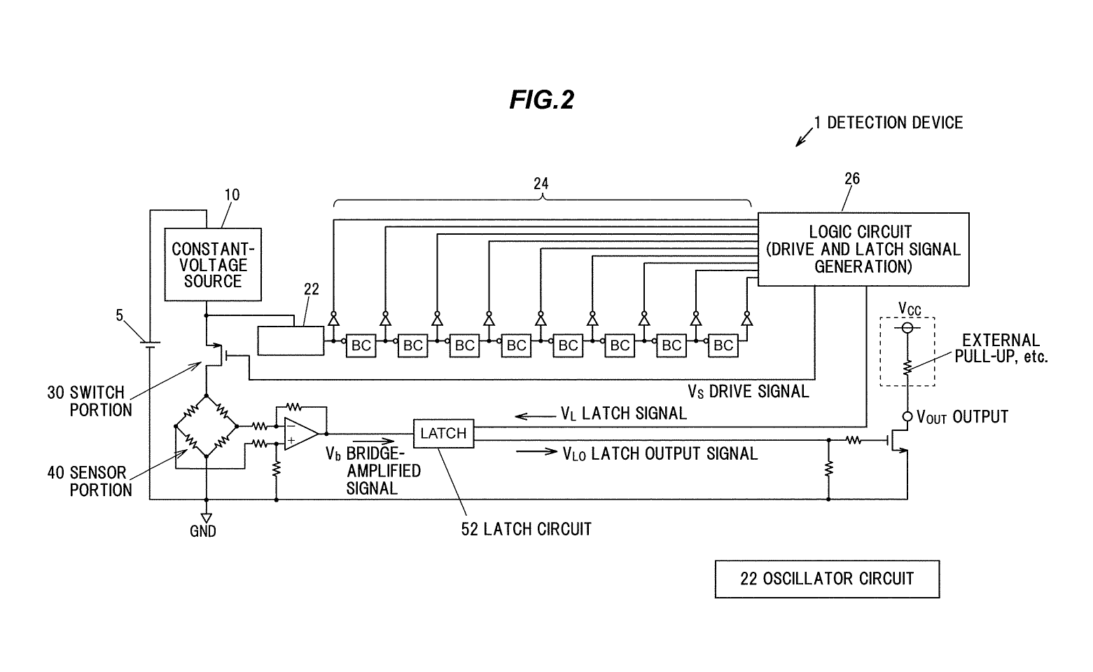

FIG. 1 is a circuit diagram showing a detection device in the first embodiment of the invention. FIG. 2 is a circuit diagram showing the detection device in the first embodiment of the invention. The first embodiment of the invention will be described in detail below in conjunction with the appended drawings. In FIG. 1, power supply lines are shown as thick solid lines and signal lines are shown as thin solid lines.

Configuration of Detection Device 1

As shown in FIG. 1, a detection device 1 in the first embodiment of the invention is composed of a constant-voltage source 10, a signal generating unit 20 generating predetermined control signals (V_{S}, V_{L}), a sensor portion 40 which receives power from the constant-voltage source 10 via a switch portion 30 being on-off controlled by the control signal V_{S} and detects a state of a measuring object, and a hold circuit portion 50 by which the output of the sensor portion 40 is held and is then output under predetermined conditions based on the control signal V_{L}.

Due to the above composition, the detection device 1 in the embodiments of the invention is capable of reducing current consumption by driving the sensor portion 40 in a time-division multiplexed manner and thus can be downsized when formed as a sensor IC.

Constant-Voltage Source 10

The constant-voltage source 10 generates a constant voltage based on power supplied from a battery 5, e.g., generates a constant voltage of +5V. The constant voltage is supplied in time division to the sensor portion 40 via the switch portion 30 (described later) and is also supplied to the signal generating unit 20 and the hold circuit portion 50, etc. As a power source which produces a constant voltage based on power of the battery 5, it is possible to use, e.g., a chopper control circuit as a DC-DC converter, a switching control circuit or a series regulator, etc. It is also possible to use a constant-voltage generating circuit which does not receive power from a battery.

Signal Generating Unit 20

The signal generating unit 20 is composed of an oscillator circuit 22, a frequency divider circuit 24 and a logic circuit 26, etc. The oscillator circuit 22 is, e.g., a solid-state oscillator circuit such as crystal oscillator or ceramic resonator. The frequency divider circuit 24 is a circuit which generates a pulse signal of which frequency is sequentially divided in half by a flip-flop as shown in FIG. 2. The logic circuit 26 is a circuit which generates a drive signal V_{S} and a latch signal V_{L}, etc., as control signals based on the generated pulse signal. The signal generating unit 20 operates with power at a constant voltage which is supplied from the constant-voltage source 10 and is received as a drive souse to perform the above-mentioned oscillating, frequency division and logic operations.

Switch Portion 30

The switch portion 30 is arranged between the constant-voltage source 10 and the sensor portion 40, and controls on/off of voltage supply from the constant-voltage source 10 to the sensor portion 40 based on the drive signal V_{S} from the signal generating unit 20. The switch portion 30 is, e.g., a PMOS transistor which has source and drain terminals respectively connected to the constant-voltage source 10 and the sensor portion 40 and controls on/off of voltage supply to the sensor portion 40 based on the drive signal V_{S} input to a gate terminal.

Sensor Portion 40

The sensor portion 40 is formed as a detection circuit with sensor bridge (bridge configuration) consisting of magnetoresistive elements (hereinafter, referred to as “MR elements”). The sensor portion 40 is constructed from a sensor bridge in which first to fourth magnetoresistive elements (hereinafter, referred to as “MR elements”) Ra, Rb, Rc and Rd are connected in a bridge form. The sensor portion 40 has a magnetic detection function, such that a state of a measuring object is detected based on midpoint voltages of the sensor bridge as a voltage change corresponding to a change in a direction of the magnetic flux relative to a magneto sensitive direction of the magnetoresistive elements and the detection result is then output.

Voltage V_{B} is supplied to the first MR element Ra and the third MR element Rc from the constant-voltage source 10 via the switch portion, while the second MR element Rb and the fourth MR element Rd are connected to GND (ground). Voltage at a connection point between the first MR element Ra and the second MR element Rb is output as a first midpoint voltage Vm1, and voltage at a connection point between the third MR element Rc and the fourth MR element Rd is output as a second midpoint voltage Vm2.

The first midpoint voltage Vm1 and the second midpoint voltage Vm2, which are the outputs from the sensor portion 40, are respectively input to a non-inverting input terminal and an inverting input terminal of an operational amplifier 60. The operational amplifier 60 outputs an amplified bridge signal V_{b} based on a differential input voltage between the first midpoint voltage Vm1 and the second midpoint voltage Vm2 and also the values of resistors R1, R2, R3 and R4. The operational amplifier 60 operates with power at a constant voltage supplied from the constant-voltage source 10.

Given that R1=R3 and R2=R4 in the differential amplifier configuration shown in FIGS. 1 and 2, the amplified bridge signal V_{b} is expressed by the equation:

V_{b}=(R2/R1)(Vm1/Vm2).

Hold Circuit Portion 50

The hold circuit portion 50 is a latch circuit 52 which outputs a latch output signal V_{LO} based on the amplified bridge signal V_{b} from the operational amplifier 60 as well as the latch signal V_{L} from the signal generating unit 20 (the logic circuit 26). The hold circuit portion 50 operates with power at a constant voltage supplied from the constant-voltage source 10.

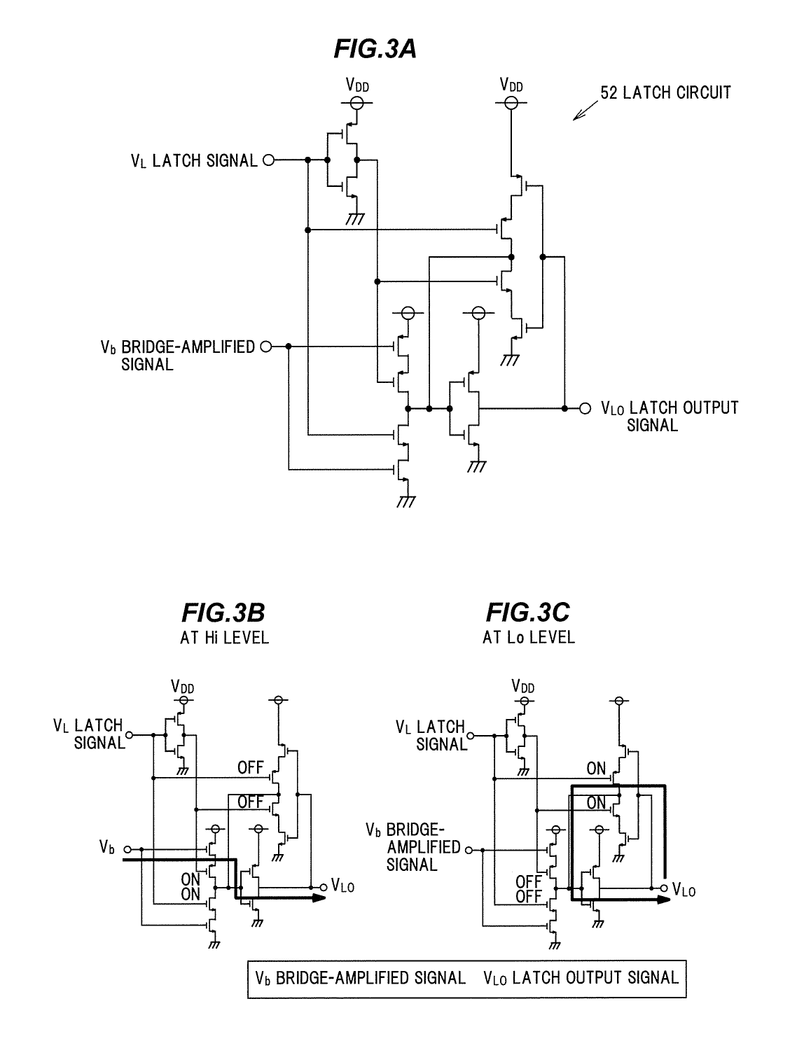

FIG. 3A is a circuit diagram showing the latch circuit 52 as a hold circuit portion of the detection device in the first embodiment of the invention, FIG. 3B is an illustration diagram showing a signal path when a latch signal is at Hi level and FIG. 3C is an illustration diagram showing a signal path when the latch signal is at Lo level.

As shown in FIG. 3A, the latch circuit 52 as the hold circuit portion 50 is a D latch circuit using a clocked inverter configured as CMOS. When the latch signal is Hi, the amplified bridge signal V_{b} is directly output as the latch output signal V_{LO}, as shown in FIG. 3B. On the other hand, when the latch signal is Lo, the amplified bridge signal V_{b} is held and the latch output signal V_{LO} is automatically fed back, as shown in FIG. 3C.

As shown in FIGS. 1 and 2, the latch output signal V_{LO} is output, through an NMOS transistor, as an output signal Vout inverted by a pull-up resistor Rp connected to external power-supply voltage Vcc.

Operation of the Detection Device 1

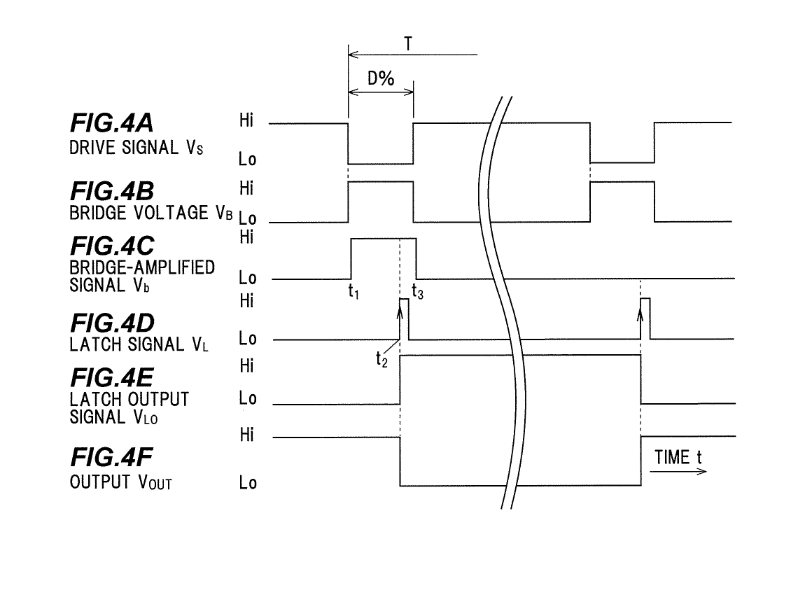

FIGS. 4A to 4F are signal waveform diagrams at various portions of the detection device in the first embodiment of the invention.

FIG. 4A is a signal waveform diagram of the drive signal V_{S} when a given drive signal is generated by the frequency divider circuit and the logic circuit and is output as the drive signal V_{S}. The signal is a digital signal alternating between Lo and Hi, and a ratio of a Lo period to a Hi period is set as a duty D %.

FIG. 4B is a signal waveform diagram of the voltage V_{B} applied to a bridge portion of the sensor portion 40. When the drive signal V_{S} is Lo, the switch portion 30 (PMOS) located upstream of the bridge is on and the voltage V_{B} applied to the bridge portion is thus Hi.

FIG. 4C is a signal waveform diagram of the amplified bridge signal V_{b}. When the voltage V_{B} applied to the bridge portion is Lo, potential is not supplied to the bridge and the amplified bridge signal V_{b} is thus Lo. On the other hand, when the voltage V_{B} applied to the bridge portion is Hi, the amplified bridge signal V_{b} is Hi or Lo depending on resistance balance of the bridge. As an example, the amplified bridge signal V_{b} shown in FIG. 4C is Hi on the left side and Lo on the right side.

In the first embodiment, gain of the operational amplifier 60 is set to a sufficiently large value by adjusting a resistance ratio R2/R1 so that output is at Hi or Lo level.

FIG. 4D is a signal waveform diagram of the latch signal V_{L}. Input timing (t2) of the latch signal V_{L} is during the Hi level state (between time t1 to time t3) of the voltage V_{B} applied to the bridge portion. Latch operation is performed in the same timing from this point forward.

FIG. 4E is a signal waveform diagram of the latch output signal V_{LO}. By the latch circuit 52, the output of the sensor portion 40 is held and is then output under predetermined conditions based on the control signal V_{L}. The latch circuit 52 latches the amplified bridge signal V_{b} when the latch signal V_{L} is input (at rise of signal). On the left side of the FIG. 4E, the latch output signal V_{LO} is latched at Hi since the amplified bridge signal is Hi when the latch signal V_{L} is input. On the right side of the FIG. 4E, the latch output signal V_{LO} is Lo since the amplified bridge signal is Lo when the latch signal V_{L} is input. As such, the output of the sensor portion 40 is held for a predetermined period of time and is then output based on the control signal (latch signal) V_{L}. In other words, the amplified bridge signals V_{b} are sequentially held during a period from an input of a latch signal V_{L} (rise of signal) to an input of next latch signal V_{L} (rise of next signal) and are then sequentially output.

FIG. 4F is a signal waveform diagram of the output V_{OUT}. The NMOS is driven by the latch output signal V_{LO}. Since the NMOS is on when the latch output signal V_{LO} is Hi, the output V_{OUT} is Lo. When the NMOS is off, the output V_{OUT} is pulled up to the power supply Vcc by the pull-up resistor and is thus Hi.

### Effects of the First Embodiment

The operation of the detection device in the first embodiment described in reference to FIGS. 4A to 4F allows the sensor portion 40 to perform detection operation and to output the detection value with bridge drive (power supply to the bridge) at a duty D %. In other words, use of a time division signal (the drive signal V_{S}) generated by the signal generating unit 20 to drive the sensor portion 40 (sensor bridge) allows current consumption of the sensor portion 40 to be controlled not only by the resistance values but also by the duty cycle. Therefore, it is possible to downsize the sensor portion 40 (sensor bridge) without increasing current consumption by appropriately setting the duty D % and thus possible to downsize the sensor IC. In addition, since the detection cycle can be set to short by shortening a repetition cycle T of the drive signal V_{S} shown in FIG. 4A, it is possible to ensure sufficient detection accuracy.

### Second Embodiment of the Invention

In the second embodiment, the output V_{OUT} is provided as an analog value by using a hold circuit as the hold circuit portion 50 and holding the output of the sensor portion 40 (sensor bridge) without saturation in operational amplifier 60. The second embodiment is different from the first embodiment in the setting of the resistance values of the operational amplifier 60 and the hold circuit portion 50, and the remaining configuration is the same. Therefore, only the differently configured portions will be described below.

Hold Circuit Portion 50

The hold circuit portion 50 is a hold circuit 54 which provides the output V_{OUT} based on the amplified bridge signal V_{b} from the operational amplifier 60 as well as the latch signal V_{L} from the signal generating unit 20 (the logic circuit 26). The hold circuit portion 50 operates with power at a constant voltage supplied from the constant-voltage source 10.

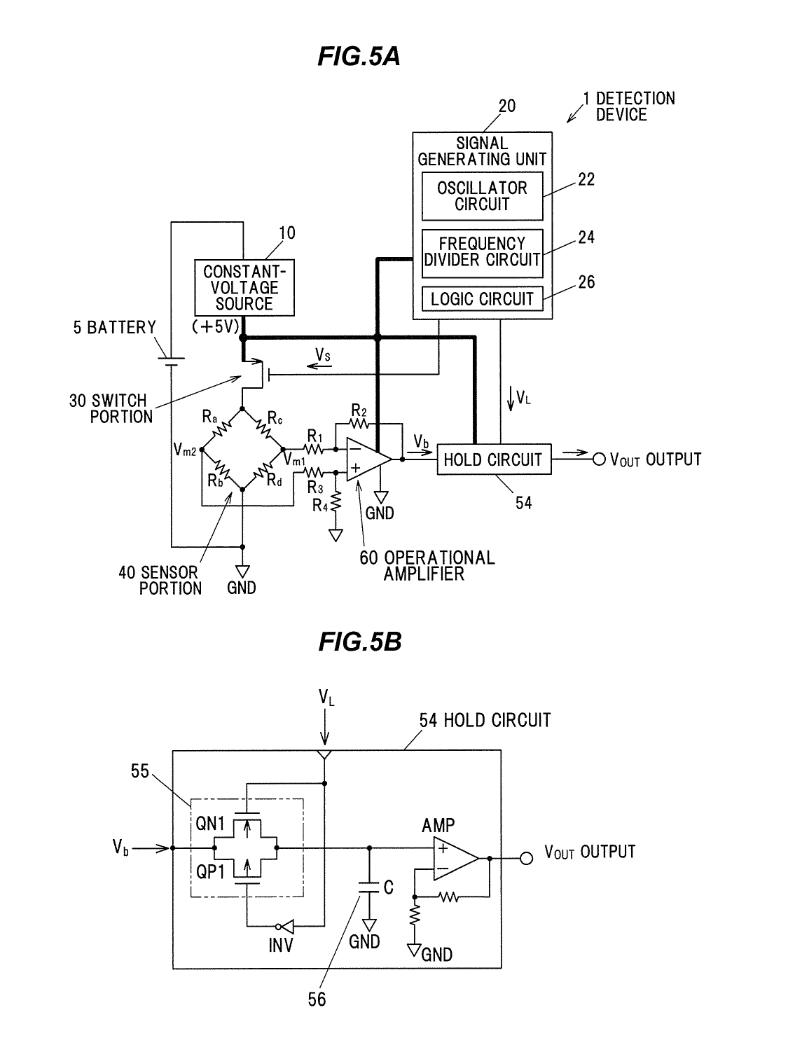

FIG. 5A is a circuit diagram showing a detection device in the second embodiment of the invention and FIG. 5B is a circuit diagram showing a hold circuit as a hold circuit portion of the detection device.

As shown in FIG. 5B, the hold circuit 54 as the hold circuit portion 50 is composed of an analogue switch 55, a hold capacitor C 56, an inverter circuit INV and an AMP.

The analogue switch 55 is configured by connecting a source terminal of an NMOS transistor QN1 to a source terminal of a PMOS transistor QP1 and a drain terminal of the NMOS transistor QN1 to a drain terminal of a PMOS transistor QP1. The latch signal V_{L} as a control signal is input to a gate terminal of the NMOS transistor QN1 and is also input to a gate terminal of the PMOS transistor QP1 via the INV. Thus, voltages applied to the NMOS transistor QN1 and the PMOS transistor QP1 are inverted from each other.

When the latch signal V_{L} is Lo, a Lo level voltage is applied to the gate terminal of the NMOS transistor QN1 and a Hi level voltage inverted by the INV is applied to the gate terminal of the PMOS transistor QP1. Therefore, each transistor is in a non-energized state.

When the latch signal V_{L} is Hi, a Hi level voltage is applied to the gate terminal of the NMOS transistor QN1 and a Lo level voltage inverted by the INV is applied to the gate terminal of the PMOS transistor QP1. Therefore, each transistor is in an energized state.

When the analogue switch 55 is in an ON-state (an energized state), the amplified bridge signal V_{b} is output as the output signal Vout via the AMP (non-inverting amplifier). Here, since charge of the amplified bridge signal V_{b} is conserved in the hold capacitor C and also input impedance of the AMP (non-inverting amplifier) is large enough, the amplified bridge signal V_{b} is still held even after finishing the high level period (level trigger) of the latch signal V_{L}.

Operation of the Detection Device 1

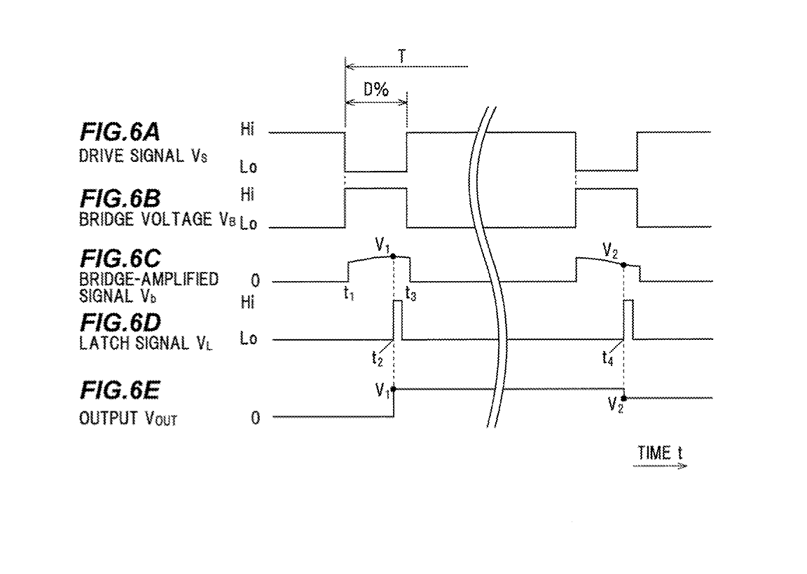

FIGS. 6A to 6E are signal waveform diagrams at various portions of the detection device in the second embodiment of the invention.

FIG. 6A is a signal waveform diagram of the drive signal V_{S} when a given drive signal is generated by the frequency divider circuit and the logic circuit and is output as the drive signal V_{S}. The signal is a digital signal alternating between Lo and Hi, and a ratio of a Lo period to a Hi period is set as duty D %.

FIG. 6B is a signal waveform diagram of the voltage V_{B} applied to the bridge portion of the sensor portion 40. When the drive signal V_{S} is Lo, the switch portion 30 (PMOS) located upstream of the bridge is on and the voltage V_{B} applied to the bridge portion is thus Hi.

FIG. 4C is a signal waveform diagram of the amplified bridge signal V_{b}. In the second embodiment, gain of the operational amplifier 60 is adjusted by a resistance ratio R2/R1 so that output is not saturated at Hi (at power-supply voltage). This allows the amplified bridge signal V_{b} to be output as an analog value in a range of, e.g., 0 to +5V. As an example, the amplified bridge signal V_{b} shown in FIG. 6C is at voltage V₁ on the left side and at voltage V₂ on the right side.

FIG. 6D is a signal waveform diagram of the latch signal V_{L}. Input timing (t2) of the latch signal V_{L} is during the Hi level state (between time t1 to time t3) of the voltage V_{B} applied to the bridge portion. Latch operation is performed in the same timing from this point forward. In the second embodiment, the latch signal V_{L} is used as a hold signal and the hold circuit 54 is operated by a level trigger in a Hi state of the latch signal V_{L}.

FIG. 6E is a signal waveform diagram of the latch output signal V_{LO}. By the latch circuit 52, the output of the sensor portion 40 is held and is then output under predetermined conditions based on the control signal V_{L}. The analogue switch 55 is turned on when the latch signal V_{L} becomes Hi at t2 and the amplified bridge signal V_{b} is held at the voltage V₁. The voltage V₁ is held even after the analogue switch 55 is turned off. As shown on the right side of FIG. 6E, the analogue switch 55 is turned on again when the latch signal V_{L} becomes Hi at t4 and the amplified bridge signal V_{b} is then held at the voltage V₂. As such, the output of the sensor portion 40 is held for a predetermined period of time and is then output based on the control signal (latch signal) V_{L}, i.e., the output V_{OUT} is provided while the amplified bridge signal V_{b} is held in a cycle T.

### Effects of the First Embodiment

The operation of the detection device in the second embodiment described in reference to FIGS. 6A to 6E allows the sensor portion 40 to perform detection operation and to output the detection value with bridge drive (power supply to the bridge) at a duty D %. In other words, use of a time division signal (the drive signal Vs) generated by the signal generating unit 20 to drive the sensor portion 40 (sensor bridge) allows current consumption of the sensor portion 40 to be controlled not only by the resistance values but also by the duty cycle. Therefore, it is possible to downsize the sensor portion 40 (sensor bridge) without increasing current consumption by appropriately setting the duty D % and thus possible to downsize the sensor IC. In addition, since the detection cycle can be set to short by shortening a repetition cycle T of the drive signal Vs shown in FIG. 6A, it is possible to ensure sufficient detection accuracy. Furthermore, since the hold circuit portion 50 is configured as a hold circuit using the analogue switch 55 and the hold capacitor C, the output V_{OUT} can be an analog output.

### Application Example 1

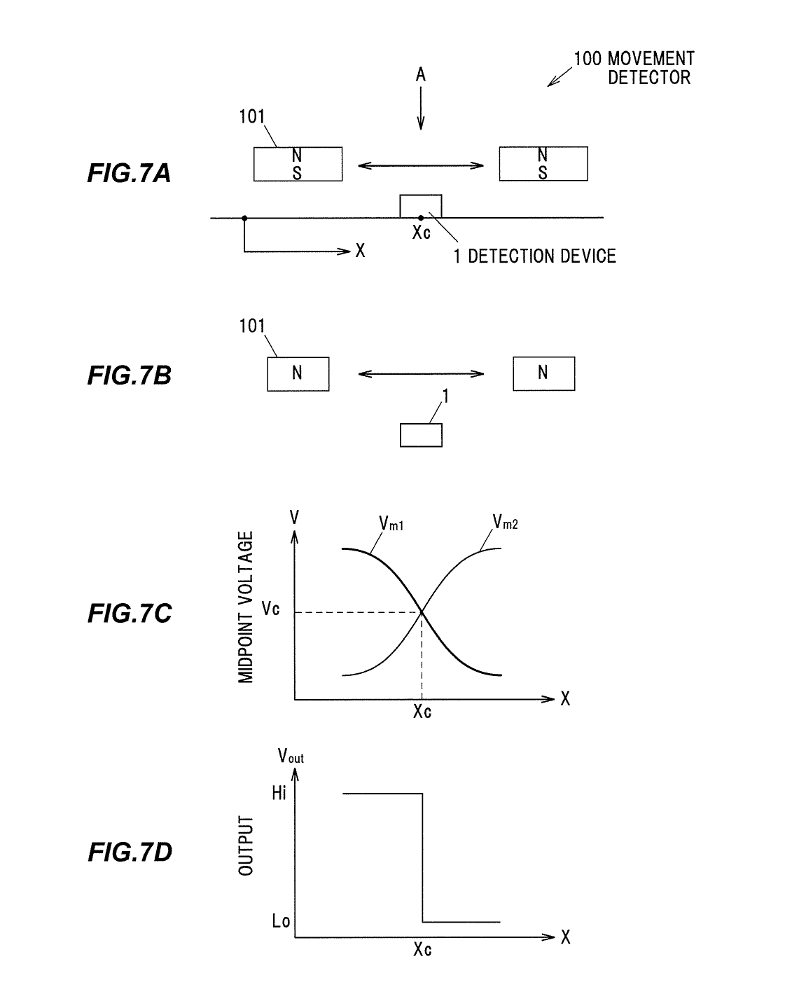

An example of applying the detection device 1 in the first embodiment to a movement detector 100 is shown in FIGS. 7A to 7D. FIGS. 7A to 7D are diagrams when the detection device in the first embodiment of the invention is used in a movement detector, wherein FIG. 7A is a front view of the movement detector, FIG. 7B is a top plan view when viewing in an A-direction of FIG. 7A, FIG. 7C is a waveform diagram illustrating a relation between a magnet position X and midpoint voltages Vm1 and Vm2 of a sensor bridge, and FIG. 7D is a signal waveform diagram illustrating the magnet position X and the output V_{OUT}.

In the movement detector 100 of FIG. 7A, the detection device 1 in the first embodiment is placed on a base and magnets 101 each having S and N poles move in an X-direction while sandwiching the detection device 1. The movement detector 100 looks like as shown in FIG. 7B when viewing in the A-direction of FIG. 7A. In other words, the magnets 101 move in the X-direction at a predetermined amplitude so that the detection device 1 in the first embodiment is an equilibrium position.

In case of such linear movement, the midpoint voltages Vm1 and Vm2 of the sensor bridge of the sensor portion 40 are as shown in FIG. 7C. In other words, the midpoint voltages Vm1 and Vm2 are equal at the position of the detection device 1 and form symmetrical signal waveforms which increase or decrease in the X-direction.

As shown in FIG. 7C, when the magnets 101 are located at the position X=Xc, the midpoint voltages Vm1 and Vm2 take the same value Vc.

By setting the gain of the operational amplifier 60 shown in FIGS. 1 and 2 to sufficiently large, the output V_{OUT} of which Hi/Lo level is inverted at the above-mentioned point (Xc, Vc) as shown in FIG. 7D is obtained.

In this application example, based on Hi/Lo of the signal, it is possible to highly accurately detect on which side of the predetermined position the moving measuring object is located, and it is also possible to realize a downsized movement detector without increasing current consumption.

### Application Example 2

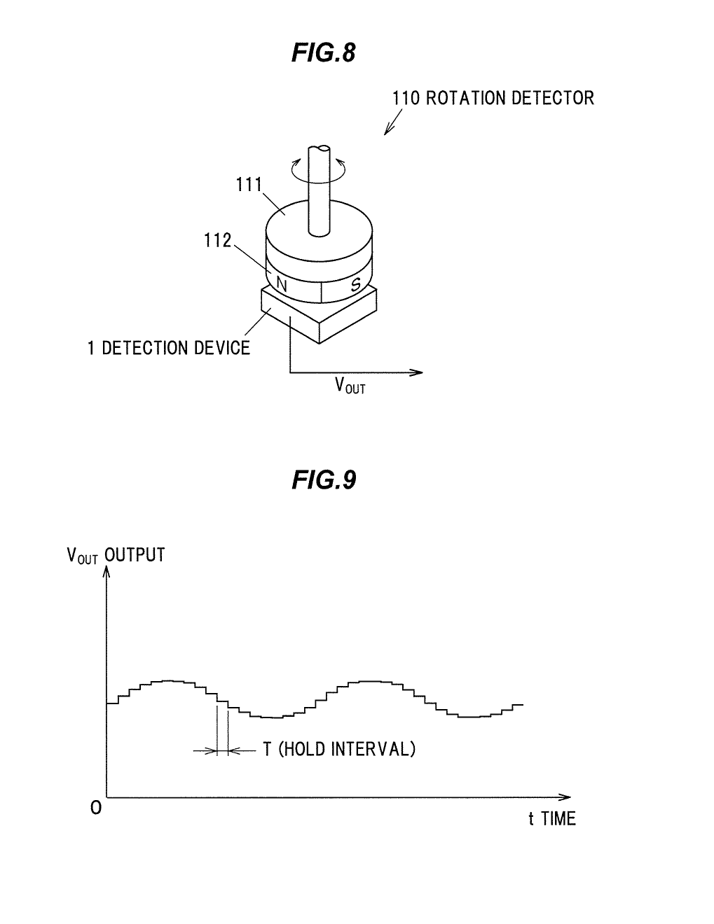

An example of applying the detection device 1 in the second embodiment to a rotation detector 110 is shown in FIG. 8. FIG. 8 is an illustration diagram showing a rotation detector when the detection device in the second embodiment of the invention is used in the rotation detector.

In the schematic diagram of FIG. 8, a magnet 112 having S and N poles is attached to a rotary member 111 of the rotation detector 110 (only partially shown) and the detection device 1 in the second embodiment is placed close to the magnet 112. The magnet 112 rotates together with the rotary member 111 when rotationally operating the rotary member 111 and the detection device 1 detects a change in a direction of the magnetic flux.

FIG. 9 is a waveform diagram showing an example of output waveform of the rotation detector 110. A change in a direction of the magnetic flux is detected as an analog value by the detection device 1 and the output V_{OUT} continuously held in the cycle T is output. It is possible to improve detection accuracy by shortening the cycle T and also possible to downsize the rotation detector 110 without increasing current consumption by controlling the duty cycle, such as controlling the duty D % to be small.

It should be noted that the invention is not intended to be limited to the embodiments and the various kinds of modifications can be implemented without departing from or changing the technical idea of the invention. For example, although the sensor portion 40 is a detection circuit with sensor bridge consisting of magnetoresistive elements, it is not limited thereto. Any circuit is applicable as long as the detection result of the state of the measuring object is output therefrom.

Although typical embodiments and illustrated examples of the invention have been described, the invention according to claims is not to be limited to the embodiments and illustrated examples. Therefore, it should be noted that all combinations of the features described in the embodiments and illustrated examples are not necessary to solve the problem of the invention.

What is claimed is:

1. A detection device, comprising:
a constant-voltage source;
a signal generating unit that generates a predetermined control signal;
a sensor portion that receives power from the constant-voltage source via a switch portion and detects a state of a measuring object, the switch portion being on-off controlled by the control signal; and
a hold circuit portion configured such that an output of the sensor portion is held and is then output under a predetermined condition based on the control signal.

2. The detection device according to claim 1, wherein the signal generating unit and the hold circuit portion receive power at a constant voltage from the constant-voltage source.

3. The detection device according to claim 1, wherein the hold circuit portion comprises a latch circuit.

4. The detection device according to claim 1, wherein the hold circuit portion comprises a hold circuit.

5. The detection device according to claim 4, wherein the hold circuit comprises an analogue switch and a hold capacitor.

6. The detection device according to claim 1, wherein the predetermined control signal comprises a time division signal.

7. The detection device according to claim 1, wherein the sensor portion comprises a sensor bridge

8. The detection device according to claim 7, wherein the sensor bridge comprises a plurality of magnetoresistive elements.
